(19) United States
(12) Patent Application Publication
(10) Pub. No.: US 2007/0068080 A1
(43) Pub. Date: Mar. 29, 2007

(54) Expandable door

(76) Inventors: Alexander Vigdorovich, St. Paul, MN (US); Michael Schafer, Long Lake, MN (US)

Correspondence Address: Angenehm Law Firm, Ltd., P.O. Box 48755, Coon Rapids, MN, 55448-0755, US

(21) Appl. No.: 11/233,952

(22) Filed: Sep. 24, 2005

(51) Int. Cl. E05D 15/20

(52) U.S. Cl. 49/130

(57) ABSTRACT

A pivoted sliding door combination, including at least one pivot joined along a first vertical edge of a pivoted door; at least one slide joining the pivoted door to a sliding door; and a structural frame of a machine safety guard device joined to the at least one pivot; the machine safety guard device further including a left side wall, a right side wall and a back wall interconnected with the structural frame.

### FIELD OF THE INVENTION

The present invention relates to expandable doors and more particularly to expandable doors for use on machine safety guard devices.

### BACKGROUND OF THE INVENTION

Industrial machinery has long included housing for protection of the worker. Guards, shields and housing are common safe guarding methods on most equipment of this type. As the regulations have increased, protection of this type has become a requirement.

These machines are large, four foot by eight foot and more. Workers need to access the machine when product or materials become jammed at various locations, to perform maintenance or to change product size. Yet, when in operation, the packaging machines are required to be enclosed to protect the worker. This has lead to enclosures with doors, allowing access when needed.

Various industry standards have been developed capturing concepts of guarding and safety. For instance, floor space is an expense that needs to be controlled, forcing more enclosed machines into smaller areas. As the doors are opened and closed, aisle space becomes even more limited between the machinery and guards. The concept of minimum aisle width is now standard within the field and is likely to remain for an exceedingly long period of time.

Technology in the area of machine safety guarding systems typically attempts to keep the doors from reaching too far into the aisle such that the aisles need to be extra wide and thereby lose valuable floor space. Manufacturers are further attempting to keep the machinery fully accessible with unimpaired walk-in, e.g., when inspection and correction are necessary.

One example is the Bosch ModelCUT-120 available at www.boschpackaging.com. This system uses a barrel roll type of scheme. The top guarding rolls up and the bottom guarding rolls down in an attempt to position the guarding out of the way of the worker. This particular system does not provide walk-in access and requires space behind the guarding for proper operation, creating both interference and using up additional floor space.

Another example is available from Harro Hoefliger, www.hoefliger.com, known as the Wallet Line. These are standard doors pivoted at the vertical edge of one door. These doors may not exceed 36 inches, thus requiring extra doors for equipment exceeding six feet in length. Moreover, even an open door can be an obstacle to work from one end of the machine to the other, when more than two doors are present. This design uses both excessive floor space and impedes access.

Marchesini sells a product under the name MA 305 which is essentially full length sliding doors. Opening one guard door impedes access to adjacent guard door assemblies. Conservation of floor space is obtained through sacrificing accessibility to the machinery.

Koerber-Medipak provide guards for blister machines at www.keorber-medipak.com. Larger upper sections move upward out of the way, while lower sections open with a hinge operation. Larger guards require more doors and operations to open the doors and panels each creating unnecessary obstructions, lost time and labor to gain access that is impeded.

What is needed is a door system that provides the necessary rigid structural support to safeguard the workers, while minimizing the amount of necessary aisle space. Furthermore, the number of guard door assemblies should be limited to allow for unimpaired, walk-in access to the machine for the purposes of inspection, maintenance, machine change-over and service, and to limit the number of additional devices such as latches and interlocks. The doors should be simple to operate with a minimum amount of force and motion needed to fully expose the internal machinery. Once constructed the guarding system should comply with all applicable domestic and international safety standards.

### SUMMARY OF THE INVENTION

The present invention includes a door system that provides the necessary rigid structural support to protect the safety of the workers. The doors, while being rigid may be structured and arranged to minimize the amount of necessary aisle space. The number of guard door assemblies is limited over a substantial length to allow for unimpaired, walk-in access to the machine for the purposes of inspection, maintenance, machine change-over and service, and to limit the framework or stops to support the guard door assemblies where necessary. The doors simplistically operate with a minimum amount of motion and force needed to fully expose the internal machinery. This guarding system complies with all applicable safety standards.

The present invention may be considered as a pivoted sliding door combination. Most preferably, the invention is combined with a other machine safety guarding devices which may safeguard packaging machines. The pivoted sliding door combination includes at least one pivot (such as a hinge) joined along a first vertical edge of a pivoted door. The door may be joined to any suitable framework. At least one slide joins the pivoted door to a sliding door. In particular, the pivoted door, slide and sliding door are arranged to expand and contract the width of the pivoted sliding door combination.

Advantageously, the pivoted sliding door may be contracted to allow adequate aisle space when pivoted open and expanded to cover a much larger opening when in a pivoted closed position.

Also as an advantage, the pivoted sliding door may be mounted in tandem further shrinking the aisle space occupied by open doors.

As still another advantage the present invention allows for unimpaired walk-in access to the machine for the purposes of inspection, maintenance, machine change over and service.

As an even further advantage the present invention limits the number of guard door assemblies required to create a guarding system over a substantial length.

Another advantage is that the present invention reduces the number of motions required to open the guarding door assemblies, such that quick easy access is provided to maintain the machine.

Another important advantage is the present invention minimizes aisle space necessary to permit full operation of the guard door assembly, while gaining unobstructed access to the machine.

As yet a further advantage, the sliding door may be slid open prior to opening the pivoted door, thereby reducing the force on the pivots and providing a longer wear life with lesser pivots than an non-sliding pivoted door.

These and other advantages will become clear through reading the below description with reference to the appended drawings.

### DESCRIPTION OF THE FIGURES

FIG. 1 is a perspective view of the present invention with the doors positioned in the fully slid and pivoted closed position;

FIG. 2 is a perspective view of the present invention with the doors positioned in the fully slid open and pivoted closed position;

FIG. 3 is a perspective view of the present invention showing the left door in the fully slid closed and partially pivoted open position and the right door in the fully slid and partially pivoted open position; and

FIG. 4 is a perspective view of the present invention showing the left door in the fully slid closed and pivoted open position and the right door in the fully slid and pivoted open position.

The figures are intended to be illustrative of the invention and are not necessarily presented to scale. Minor modifications may be made by those with ordinary skill in the art without departing from the spirit and scope of the invention such as using pivots that allow the doors to pivot open even further.

### DETAILED DESCRIPTION

A machine safety guard device 10 is provided with a left side wall 12, a right side wall 14 and a back wall 16 interconnected with a structural frame 18 and a right side pivoted sliding door 30 and a left side pivoted sliding door 50. Walls 12, 14, and 16 are joined to the structural frame 18 in such a manner as to be able to enclose at least a portion of a packaging machine or other equipment. The right side pivoted sliding door 30 and the left side pivoted sliding door 50 operate in conjunction with the walls 12, 14, and 16 to completely encapsulate a packaging machine, while also being operable to fully exposes the desired area of the packaging machine or other equipment. The walls 12, 14, 16, and pivoted sliding doors 30, 50 can be manufactured from a variety of materials, but typically from see-through, shatter resistant material, which allows visual inspection therethrough and are mounted perpendicular to a standard floor. These components will be discussed in serial fashion.

The right side pivoted door 30 is generally comprised of a pivoted door 34 and sliding door 38. The right side pivoted sliding door 30 may be joined to the structural frame 18. At least one right pivot 32 (such as a hinge), perhaps secured along a vertical edge 33 of the pivoted door 34, joins the right pivoted door 34 of the right side pivoted sliding door 30 to the structural frame 18. At least one right slide 36 preferably joins the right pivoted door 34 to a right sliding door 38. The right pivoted door 34, right slide 36 and right sliding door 38 are arranged to expand and contract the width of the right pivoted sliding door combination 30, e.g. telescoping horizontally such that the fully extended width is wider than either the right pivoted door 34 or right sliding door 38. The right pivoted door 34 and the right sliding door 38 are independently operable. Thus, the right side pivoted sliding door 30 has four full positions, namely fully slid and pivoted closed, fully slid open and pivoted closed, fully slid closed and pivoted open, and fully slid and pivoted open. (As used throughout this application full position is defined to mean that the door is moved to its fullest extent in one of the door's directions of movement, e.g. fully open or fully closed.)

The left side pivoted sliding door 50 is generally comprised of a pivoted door 54 and a sliding door 58. The left side pivoted sliding door 50 may be joined to the structural frame 18. At least one left pivot 52 (such as a hinge), perhaps secured along a vertical edge 53 of the pivoted door 54, joins a left pivoted door 54 to the structural frame 18 and at least one left slide 56 joins the left pivoted door 54 to a left sliding door 58. The left side pivoted sliding door 50 is preferably a mirror image of the right side pivoted sliding door 30 with the respective pivots secured at the respective corners of the machine safety guard device. The pivoted door 34,54, slide 36,56 and sliding door 38,58 being arranged expand and contract the width of the pivoted sliding door combination 30,50.

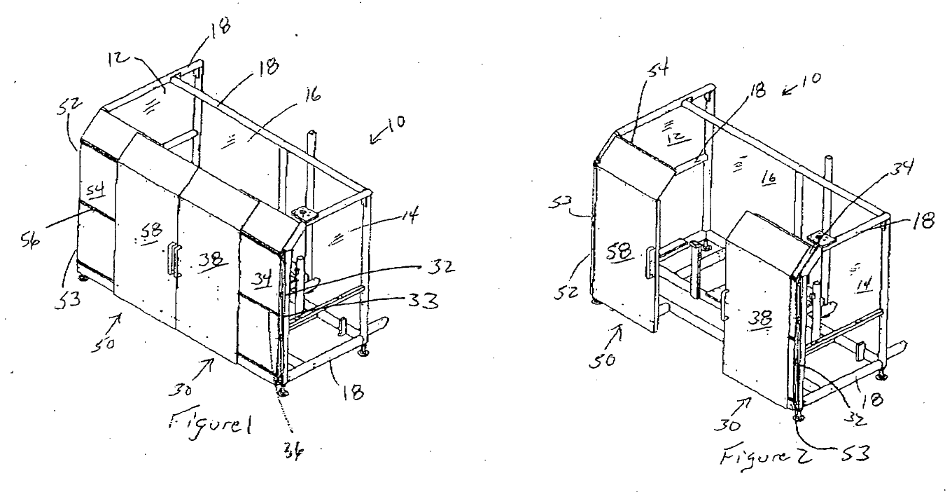

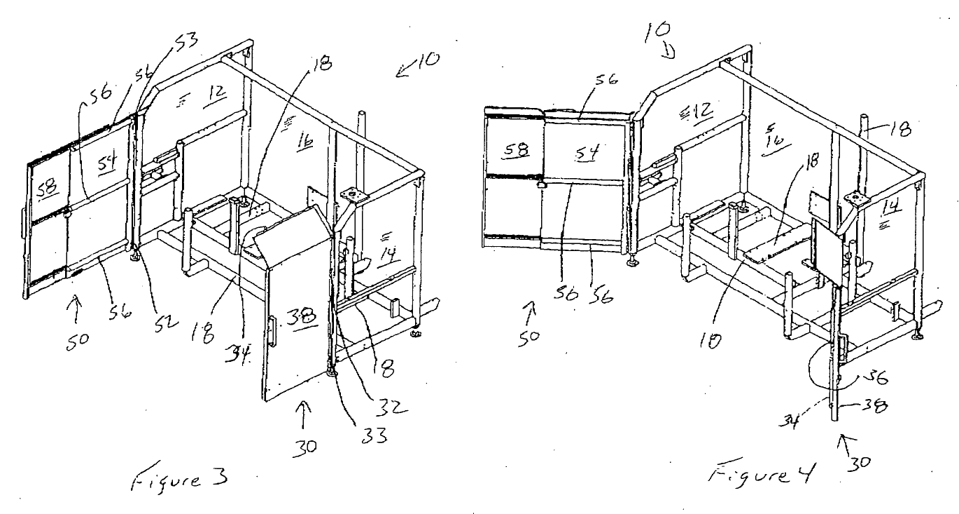

The left side pivoted sliding door 50 has four full positions, namely fully slid and pivoted closed, fully slid open and pivoted closed, fully slid closed and pivoted open, and fully slid and pivoted open. The fully slid and pivoted closed position is shown in FIG. 1 to have the left side pivoted sliding door 50 fully closed. The fully slid open and pivoted closed position is shown in FIG. 2 with the left sliding door 58 fully open and the left pivoted door 54 fully closed. The fully slid closed and pivoted open position is shown with regard to the right side pivoted sliding door 30 in FIGS. 3 and 4, while the fully slid and pivoted open position is shown with regard to the left side pivoted sliding door 50 in FIGS. 3 and 4. Note, doors 30 and 50 in FIGS. 3 and 4 are not open to the same degree, which demonstrates that one of ordinary skill in the art can, through selection of pivots or other structural modifications, determine the full extent that the door 30, 50 can be opened. Desirably, doors 30,50 open at least 90 degrees and preferably doors 30,50 open at least 135 degrees.

One of the four positions, fully slid closed and pivoted open, is not a particularly desirable position as it consumes aisle space. One skilled in the art may provide a locking mechanism that precludes moving the pivoted door 34, 54 until the sliding door 38, 58 is fully closed. Such a locking mechanism is not to be interpreted as to restrict the door to three positions. The fourth position is still present, albeit not engageable due to the locking mechanism.

Although the present invention has been described with reference to preferred embodiments, workers skilled in the art will recognize changes may be made in form and detail without departing from the spirit and scope of the invention.

1) A machine safety guard device, comprising:
a left side wall, a right side wall and a back wall interconnected with a structural frame;
a right side pivoted sliding door joined to the structural frame having at least one right pivot joining a right pivoted door to the structural frame, and at least one right slide joining the right pivoted door to a right sliding door, the right side pivoted sliding door having four full positions, namely fully slid and pivoted closed, fully slid open and pivoted closed, fully slid closed and pivoted open, and fully slid and pivoted open; and
a left side pivoted sliding door joined to the structural frame having at least one left pivot joining a left pivoted door to the structural frame, and at least one left slide joining the left pivoted door to a left sliding door, the left side pivoted sliding door having four full positions, namely fully slid and pivoted closed, fully slid open and pivoted closed, fully slid closed and pivoted open, and fully slid and pivoted open.

2) A pivoted sliding door combination, comprising:
at least one pivot joined along a first vertical edge of a pivoted door; and
at least one slide joining the pivoted door to a sliding door, the pivoted door, slide and sliding door being arranged to expand and contract the width of the pivoted sliding door combination.

3) The door combination of claim 2 wherein the door is a right pivoted sliding door mounted on the front of a machine safety guard device.

4) The door combination of claim 2 wherein the door is a left pivoted sliding door mounted on the front of a machine safety guard device.

5) The door combination of claim 2 further being joined to a structural frame of a machine safety guard device, the machine safety guard device further including a left side wall, a right side wall and a back wall interconnected with the structural frame.

6) The door combination of claim 2 wherein the door has four full positions.

7) The door combination of claim 6 having a full position of fully slid and pivoted closed.

8) The door combination of claim 6 having a full position of fully slid open and pivoted closed.

9) The door combination of claim 6 having a full position of fully slid closed and pivoted open.

10) The door combination of claim 6 having a full position of fully slid and pivoted open.

11) The door combination of claim 2 being a first door and being operably positioned to a second door.

12) The door combination of claim 11 wherein the second door is a pivoted sliding door.

13) The door combination of claim 12 wherein the second door includes
at least one pivot joined along a first vertical edge of a pivoted door of the second door; and
at least one slide joining the pivoted door of the second door to a sliding door of the second door.

14) The door combination of claim 12 wherein the second door has four full positions.

15) The door combination of claim 14 having a full position of fully slid and pivoted closed.

16) The door combination of claim 14 having a full position of fully slid open and pivoted closed.

17) The door combination of claim 14 having a full position of fully slid closed and pivoted open.

18) The door combination of claim 14 having a full position of fully slid and pivoted open.

19) A pivoted sliding door combination, comprising:
at least one pivot joined along a first vertical edge of a pivoted door;
at least one slide joining the pivoted door to a sliding door; and
a structural frame of a machine safety guard device joined to the at least one pivot, the machine safety guard device further including a left side wall, a right side wall and a back wall interconnected with the structural frame.

20) The door combination of claim 19 further comprising:
at least one second pivot joining a first vertical edge of a second pivoted door to the structural frame; and
at least one second slide joining the second pivoted door to a second sliding door.
